(19) United States
(12) Patent Application Publication
(10) Pub. No.: US 2003/0131063 A1
(43) Pub. Date: Jul. 10, 2003

(54) Message processor

(76) Inventor: David L. Breck, Epping, NH (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/326,533

(22) Filed: Dec. 19, 2002

Related U.S. Application Data
(60) Provisional application No. 60/341,897, filed on Dec. 19, 2001.

(51) Int. Cl. G06F 15/16

(52) U.S. Cl. 709/206

(57) ABSTRACT

Methods and systems for processing a message, the methods and systems including providing a first level of message processing rules, providing at least one second level of message processing rules, determining at least one message attribute associated with the message, and based on the determined message attribute(s), the first level of message processing rules, and the at least one second level of message processing rules, processing the message based on one or more preferences associated with a trusted message, a blocked message, or an unknown message. The preferences can be associated with the first level and/or the second level(s).

### CLAIM OF PRIORITY

This application claims priority to U.S. S. No. 60/341,897 filed on Dec. 19, 2001, naming David Breck as inventor, the contents of which are herein incorporated by reference in their entirety.

### BACKGROUND

(1) Field

The disclosed methods and systems relate generally to filtering schemes, and more particularly to filtering schemes applied to electronic messages.

(2) Description of Relevant Art

The increase in electronic communications such as electronic mail (email) and short message service (SMS), coupled with capabilities to electronically access and/or create databases of potential addressees of such electronic communications, creates opportunities for advertisers, solicitors, and others to generate and send unsolicited electronic messages to unsuspecting addressees or users. The frequency and number of such unsolicited and often unwelcome messages warranted the coining of a term “spam” to describe what some may deem “junk email.” In certain parts of the world, the problem can be primarily associated with email, however, in certain jurisdictions and/or regions, the spam issue translates similarly to SMS and/or other electronic messaging schemes.

In an email context, spam can result, for example, from a given user, known herein as the email recipient, providing an email address at a website. In one situation, the email recipient may purchase an item, register for a course, or otherwise provide the recipient's email address for a confirmation. The recipient's email address may be placed in a database or other storage associated with the website owner/manager, and the contents of such database (e.g., email addresses and/or user profile information) may be sold to or otherwise provided to other marketers, promoters, etc. Additionally and/or optionally, the website owner/manager may use the recipient's email address (and others in the database) for purposes other than the immediate purpose (e.g., provide an email confirmation). For example, the website owner/manager may be a retailer from whom the email recipient made a purchase. In the future, the website owner/manager may send the email recipient promotional emails announcing sales, coupons, newsletters, etc. Although one email recipient may consider these promotional emails interesting and informative, another email recipient may consider these same promotional emails to be spam. The same predicament can be applied to SMS and other message-type recipients.

Present systems addressing the spam problem block or otherwise eliminate email messages based on the email source and/or the content. In the aforementioned example, therefore, where a retailer/merchant may send promotional emails to two users in the same domain, user A and user B, user A may wish to view such promotional email, but user B may not. Existing spam elimination/blocking systems generally do not address the different desires of the two users. Further, such systems can be ineffective in allowing a user determine that emails from a given source may no longer be desired, or alternately, that emails previously undesired from a given source, may be desired for a given amount of time.

### SUMMARY

The disclosed methods and systems include methods and systems for processing a message, including identifying at least one message recipient, associating the recipient(s) with at least two processing levels where the processing levels including at least one processing rule, associating at least one message attribute with the message, and, processing the message based on applying the message attribute(s) to the processing rule(s) in the at least two processing levels. The recipient(s) can include, in one embodiment, a recipient user, a domain administrator, a network and/or system administrator, and/or a server that may be associated with the message. The message can include at least one of an email, telephony data, Short Message Service (SMS) data, at least one ASCII character, at least one non-ASCII character, and at least one binary digit. The two or more processing levels can include a Recipient user level, a User Group level, a Domain Administrator level, a Domain Group Administrator level, and/or a System Administrator level.

The processing rule(s) can include at least one association that includes at least one address identifier, and the address identifier can include at least one user ID, at least one domain, and/or at least one network. The processing rule can include an association that includes at least one wildcard. The processing rule can include at least one filter, and in one embodiment, can include at least one association with a trusted address and a blocked address.

The message attribute(s) can include at least one of a source address, a source recipient user, a source domain, a source network, a recipient address, a recipient user, a recipient domain, a recipient network, a message length, message encryption, message coding, message compression, a message format, a message type, a message header, message data (e.g., message body and/or message content), a message tail, a digital certificate, and/or envelope data. Processing the message can thus include at least one of detaining the message, deleting the message, and relaying the message to the recipient(s). Processing the message can also include associating a source with the message, and, providing an error message to the source and/or sender, where the error message can be based on one or more preferences of the recipient(s).

In one embodiment, the methods and systems can further include updating the processing rule(s) based on a message(s) transmitted by the recipient(s). Additionally and/or optionally, the processing rule(s) can be updated based on a learning module.

The processing rule(s) can include a custom rule, and/or a spoof check. The spoof check can include at least one of a user type, a domain type, and/or a system type.

The methods and systems can include associating at least one of a processing priority and an order priority with the at least two processing levels. Further, at least one of an order priority and a processing priority can be associated with the message attribute(s), and the message attribute(s) can be processed at the at least two processing levels based on at least one of the order priority and the processing priority.

Processing the message can include detaining the message, and providing an interface to allow the at least one recipient to process the detained message. Processing the message can include transmitting an unknown/invalid recipient message to the message source. In one embodiment, the unknown recipient message can include an error message. Transmitting the error message can include generating an error code, and transmitting the error code based on the message sender and/or source. Transmitting the message can also include transmitting a customized message, where the customized message can be based on a preference(s) associated with at least one recipient.

The methods and systems also include methods and system for processing a message that include associating a first recipient with at least one message attribute, where the first recipient and the at least one message attribute are further associated with a trusted status or a blocked status, associating at least one second recipient with at least one message attribute, where the at least one second recipient and the at least one message attribute are further associated with a trusted status or a blocked status, determining at least one message attribute associated with the message, and, comparing at least one of the determined at least one message attribute to: the at least one message attribute associated with the first recipient, and, the at least one message attribute associated with the at least one second recipient; and, processing the message based on the comparison. The comparing can be based on at least one of: an order priority associated with the first recipient and the at least one second recipient, and an order priority associated with the determined at least one message attribute. Comparing can further include comparing the determined at least one message attribute to a custom check and/or a spoof check

Processing the message can include associating a processing priority with the first recipient and the at least one second recipient. Processing the message can include at least one of: relaying the message to at least one of the first recipient and the at least one second recipient, detaining the message, and deleting the message. The processing can be based on one or more preferences and/or processing priority(s) associated with at least one of the first recipient and the at least one second recipient.

The message can include an email, telephony data, Short Message Service (SMS) data, at least one ASCII character, at least one non-ASCII character, and/or at least one binary digit. Processing the message can include identifying that the determined at least one message attribute is neither trusted nor blocked by the first recipient and the at least one second recipient. In one embodiment, the methods and systems can include providing a report to at least one of: the first recipient and the at least one second recipient, the report including data based on processed messages.

The methods and systems can include, based on a source and/or sender associated with the message, associating at least one of the determined at least one message attributes with a trusted status, the trusted status further associated with at least one of: the first recipient and the at least one second recipient. The first recipient and/or the second recipient(s) can include at least one of: at least one recipient user, at least one user group administrator, at least one domain administrator, at least one domain group administrator, and at least one system administrator.

Also disclosed are methods and systems for processing a message, including associating attributes with the message, based on processing rules of at least two processing levels and the message attributes, classifying the message as one of: trusted, blocked, and unknown; and, based on the classification, performing at least one of: relaying the message to a recipient, detaining the message, and deleting the message. Associating attributes with the message can include associating at least one of: a source address, a source recipient user, a source domain, a source network, a recipient address, a recipient user, a recipient domain, a recipient network, a message length, message encryption, message coding, message compression, a message format, a message type, a message header, message data (e.g., message body, message content, etc.), a message tail, a digital certificate, and envelope data. The at least two processing levels can include at least two of: a recipient user, a user group administrator, a domain administrator, a domain group administrator, and a system administrator. The processing rules can include associations of message attributes with at least one of a trusted state and a blocked state. The processing rules can include at least one wildcard.

Disclosed are methods and systems for processing a message, including providing a first level of message processing rules, providing at least one second level of message processing rules, determining at least one message attribute associated with the message, based on the determined at least one message attribute, the first level of message processing rules, and the at least one second level of message processing rules, processing the message based on one or more preferences associated with a trusted message, a blocked message, or and unknown message. The first level of message processing rules and/or the second level of message processing rules can associate at least one message attribute with a trusted state or a blocked state. Processing the message based on one or more preferences associated with at least one of a blocked message and an unknown message can include detaining the message. Processing the message based on one or more preferences associated with at least one of a blocked message and an unknown message can include sending an error code and/or an error message. Processing the message based on recipient(s) preference(s) associated with a trusted message can include at least one of: relaying the message to a message recipient, and releasing detained messages associated with the message. Providing a first level and/or second level of message processing rules can include associating at least one message attribute with a trusted state or a blocked state.

The preferences for trusted, blocked, and/or unknown messages can be associated with the first level and/or the second level(s). Processing an unknown message can include relaying the message to at least one message recipient.

The disclosed methods and systems include processing a message by associating at least one of the message content (e.g., message data, message “from” field(s), message “to” field(s), etc.) and the message source with a sender identity, where the sender identity is associated with at least one of a system user and a user in a system domain, based on at least one first preference of at least one recipient, authenticating the sender identity, and, based on at least one second preference of the at least one recipient, processing the message. Authenticating the sender identity includes authenticating based on at least one message attribute, and can include authenticating based on at least one of source ID, source domain, and source network.

The at least one first preference can include a spoof check type, where the spoof check type can include at least one of a user type, a domain type, a system type, a default type, and none. The at least one first preference can include at least one preference associated with at least a recipient user, a domain administration, and/or a system administrator. The at least one second preference can include a spoof check preference, where the spoof check preference can include detaining the message, relaying the message to the at least one recipient, blocking the message, deleting the message, and/or stealthing the message source.

Accordingly, authenticating the user can include authenticating the source with the recipient user(s), authenticating the source with a domain associated with the recipient, and authenticating the source with a system domain. Authenticating the source with the recipient(s) user can include authenticating the source ID with a recipient ID. Authenticating the source with a domain associated with the at least one recipient can include authenticating the source domain with a recipient domain. Authenticating the source with a system domain can include authenticating the source network with a domain associated with a system, where the system can be associated with the recipient domain. The authenticating can include processing a login name and a password, network entity (e.g., IP address), and/or AUTH data, although other authentication methods can be used.

The methods and systems include a method of processing a message, including receiving the message via a message protocol, associating the message with a source, based on the source, the message content, and/or at least one preference of at least one message recipient, providing an error condition in accordance with the message protocol, the error condition indicating that the message recipient is not valid. The message protocol can include MASM, Simple Mail Transfer Protocol (SMTP), and/or Wireless Application Protocol (WAP). The method can also include processing data associated with the message and processing the message data.

The error condition indicating that the recipient is not valid can include an error condition indicating that the recipient is not known, or an equivalent condition. Providing the error condition can include transmitting the error condition based on the protocol, and can further include associating an error message with the error condition, where providing an error condition can include providing the error message. The error message can be provided in accordance with the protocol. The provided error message can be a default error message and/or an error message customized by the recipient(s). In one example when the message protocol is SMTP, the error condition can be error condition 550. The message recipient can include a system user as provided herein.

Other objects and advantages will become apparent hereinafter in view of the specification and drawings.

### BRIEF DESCRIPTION OF THE DRAWINGS

FIG. 1 is an illustrative block diagram of a system and method for transmitting messages;

FIG. 2 is an illustrative block diagram of a system and method for transmitting messages, where such system includes a message server;

FIG. 3 illustrates one embodiment of a message server;

FIG. 4 is an exemplary interface for managing detained messages;

FIG. 5 is an exemplary interface for designating custom checks/rules;

FIG. 6 is an exemplary interface for providing a login name and password;

FIG. 7 is an exemplary interface for providing user settings that includes options to receive reports via email, stealth options, unknown sender/source processing options, spoof checking options, stealth message options, detention lifetime options, and reporting interval options, amongst other options;

FIG. 8 is an exemplary embodiment providing statistics of message processing;

FIGS. 9a and 9b illustrate exemplary interfaces for stealthed reporting and trusted designations, respectively;

FIG. 10 provides an exemplary user interface for managing a system user account;

FIG. 11 illustrates one block diagram for incoming message processing;

FIG. 12 illustrates one block diagram for hierarchical processing of incoming messages;

FIGS. 13-21 illustrate one series of variations for hierarchical processing of incoming messages.

### DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the disclosed systems or methods.

The disclosed methods and systems relate generally to processing electronic messages, where such electronic messages can include electronic mail (email) messages, short message service (SMS) messages, telephony, and other electronic messages/communications technologies. The electronic messages can include ASCII and/or non-ASCII characters, can be encoded, encrypted, and/or can otherwise be reduced to binary data. References herein to a “message” can accordingly be understood to include references to one and/or more of the aforementioned electronic messages. The disclosed methods and systems allow a message recipient to generate or otherwise create one or more processing rules, where a processing rule can delineate or otherwise include message sources/senders that are trusted (acceptable) and/or blocked (not acceptable), where a message recipient or “a recipient” can be understood with reference to the illustrated embodiments to be an individual user, a domain associated with the user, and/or a network associated with the user. Those of ordinary skill in the art will recognize references herein to a recipient or the recipient can be understood to encompass users of the system 12 at various levels, which as provided herein can vary based on the embodiment. The processing rules can thus be generated by authorized individuals associated with the Recipient user account, recipient domain, and/or recipient network. Accordingly, the disclosed methods and systems can allow or otherwise provide for a hierarchical set of message processing rules or filters, where a received message can be parsed and/or analyzed for source information/data and such source information can be processed in a hierarchical manner based on the message processing rules, to determine whether the message should be delivered to the individual user, or detained for review by the user. It may be understood that source information can be derived not only from the message content, but also from events and/or other data associated with the message, such as, for example, message protocols (e.g., handshake(s), transaction activity, etc.) and/or other communications methodologies.

Those of ordinary skill in the art will recognize that the terms “trusted state” and “blocked state” are merely illustrative, and other designations for such categories can be used.

In one embodiment, the message processing rules can be understood to be and/or otherwise include or be associated with filters, where such filters can be implemented as logic filters. A message can thus be applied to the filter, and/or vice-versa, where such filter can include one or more wild-carded elements, to determine whether the filter applies to the message. In one embodiment, if the filter applies to the message, one or more associated processing rules can be applied to the message. In one example of a wild-card, a filter can include specifying users associated with a given domain by specifying “*.sampledomain.com.”

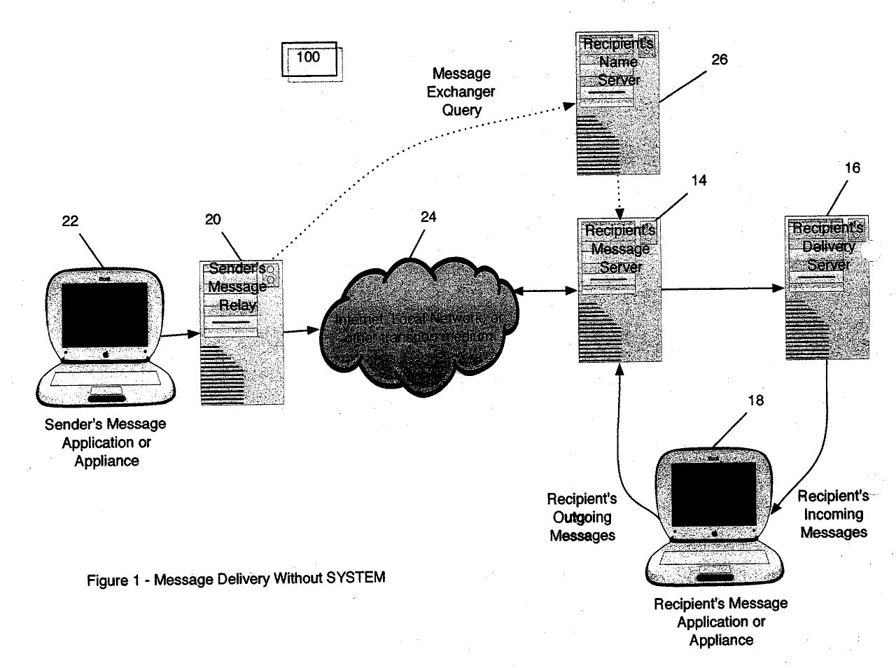

FIG. 1 illustrates one embodiment of a message system that can be associated with, for example, one type of message system known as an email system 100 that includes an email sender 22 connected to a network such as the internet 24 via a sender Simple Mail Transfer Protocol (SMTP) server 20. The SMTP server 20 can query a Domain Name System (DNS) server 26 associated with the email recipient, where the DNS server 26 can reply to the DNS inquiry with data that can include, for example, the recipient's domain IP address, list of email exchangers, and other data to allow the transmission of the email to the recipient. Accordingly, the source/sender's SMTP server 20 can transmit the email message to the recipient's SMTP server 14. The recipient's SMTP server 14 can hence transmit the email message to the recipient's mail delivery server 16, which can thereafter provide the email message to the Recipient user 18 using protocols such as Point of Presence (POP), Internet Message Access Protocol (IMAP), Microsoft Exchange, Web-based mail, etc. Those of ordinary skill will recognize that the protocols described herein are merely illustrative, and as with other illustrated embodiments herein, FIG. 1 can be understood to be exemplary and extendable to other message embodiments. Further, it can be understood that the recipient's SMTP server 14 and mail delivery server 16 can be combined to a single server, although other such combinations can be comtemplated.

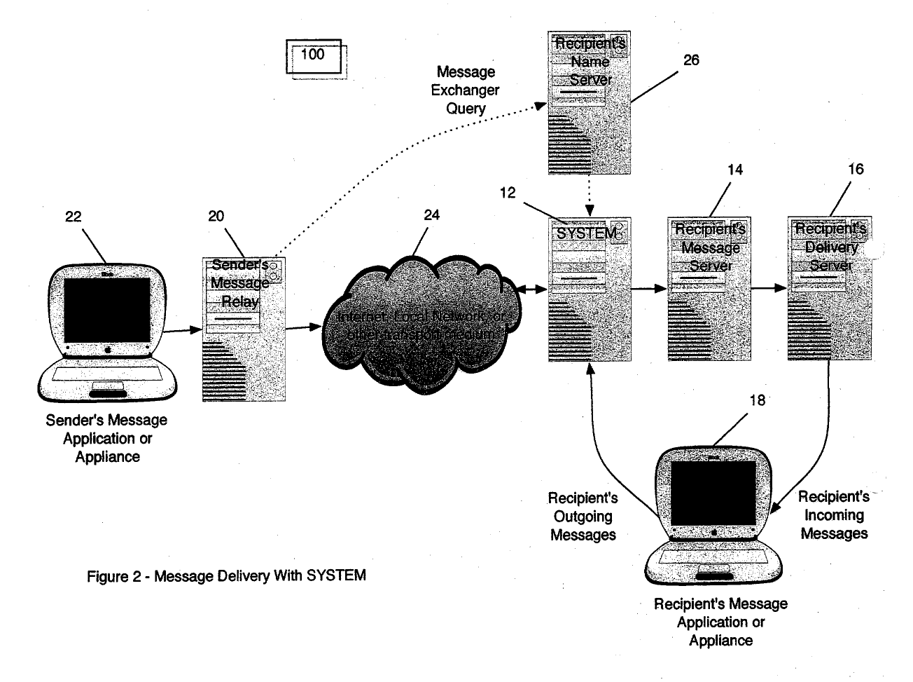

FIG. 2 provides one illustrative embodiment of the disclosed methods and systems that includes one or more message senders 22 connected to a network such as the internet 24 to send an electronic message via a sender SMTP server 20. The aforementioned DNS query provided relative to FIG. 1 can occur, whereby messages can be transmitted by the sender's SMTP server 20 to a message management server 12 associated with the recipient's SMTP server 14. The message management server 12 can process received messages as will be provided herein, and based on such processing, can transmit the message(s) to the recipient's SMTP server 14, which can transmit the message(s) to the recipient's mail delivery server 16, whereupon the message(s) can be transmitted or otherwise provided to the Recipient user using protocols such as POP, IMAP, Microsoft Exchange, Web-based mail, etc. Messages transmitted by the illustrated “recipient,” alternately, can be communicated directly from the user to the message management server 12 via, for example, SMTP or another protocol. Accordingly, the illustrated recipient can be associated with a processor-controlled device that can be equipped for receiving messages, and such device can further be capable of transmitting and/or receiving messages via wired and/or wireless communications channels using corresponding communications protocols.

The system 12 can be understood to be one or more servers which can process incoming messages based on a hierarchical processing method and system that can be structured differently based on an embodiment, but for the illustrated embodiments, can be understood to include at least three hierarchical processing levels that can be referred to as a System level, a Domain level, and a Recipient user level, while those of ordinary skill in the art will recognize that the illustrated embodiments that include three levels are merely illustrative with similarly illustrative names, and the hierarchical processing can be achieved with two or more levels. Further, the names of “system” and “domain” can be understood to be illustrative of one embodiment, and such names can be applicable to systems where, for example, domains may not be configured.

For the illustrated systems and methods, a “domain” can be understood to include one or more Recipient users, and a “system” can be understood to include one or more domains. Accordingly, a domain can be associated with a Domain Administrator, and a network can be associated with a System Administrator.

For the illustrated systems that include three processing levels, in one illustrative embodiment, for incoming messages, a message processing rule provided by a System Administrator can be understood to have processing order priority (“order priority”) relative to message processing rules provided by a Domain Administrator and a Recipient user, and similarly, a message processing rule provided by a Domain Administrator can have processing order priority relative to processing rules provided by a Recipient user. References herein to order priority can be understood to indicate, for example, that a processing rule (e.g., designation of a user as trusted or blocked) provided by a System Administrator can be considered prior to a processing rule provided by a Domain Administrator and/or a Recipient user, although as provided herein, the systems and methods can allow a Recipient user (e.g., comparatively lower level processing level) to provide a processing rule that can selectively override, negate, or otherwise direct message processing regardless of a System Administrator processing rule. Accordingly, processing priority can refer to whether one hierarchical level's processing rule may be enacted regardless of a processing rule of another hierarchical level.

The aforementioned message processing rules can be understood to be a set of instructions (e.g., processor-executable instructions) and/or an associated set of data that can be interpreted as a set of instructions. As previously provided herein, the message processing rules can also be associated with or otherwise include a filter. In the illustrated embodiments, the processing rules can be understood to include data associations that can associate message attributes such as a source, a source domain, and/or a source network, with a desired processing action (e.g., relay message to a recipient, detain message, forward message, delete message, stealth the message, generate error code/condition, etc., for example). Accordingly, a processor can determine a processing action associated with a given source/sender, and execute instructions for processing the received message. For example, a Recipient user can create or otherwise designate a list of users, domains, and/or networks, and indicate whether such users, domains, and/or networks can be “trusted” or “blocked.” For the purposes of the illustrated embodiments, a designation of “trusted” can indicate that the Recipient user wishes to receive messages from the associated message source/sender, and accordingly, such processing rule can cause a delivery of the message (“relay”) to the Recipient user. In the illustrated embodiments, alternately, a designation of “blocked” can indicate that a Recipient user does not wish to receive messages from the associated message source/sender. As will be provided herein, a Recipient user can further associate other message processing rules and/or actions with blocked messages, such that blocked messages can be processed based on at least one of an accept/relay module, stealth module, a discard module, and a detain module, although other modules can be used.

The disclosed methods and systems can allow users and/or administrators at the hierarchical levels to generate message processing rules, where such message processing rules can be based on attributes of the messages to be processed. Different hierarchical levels may associate processing rules with the same message attribute, and thus the methods and systems may enact or otherwise process the message in accordance with a hierarchical level that may have processing priority for a given attribute. As provided herein, order priority (e.g., determining in which order a hierarchy may be traversed) can be different from processing priority (e.g., determining which rule in the hierarchy to process).

As an example, for the illustrated embodiments where a message can be associated with or otherwise understood to include attributes having a source network, a source domain, and a source identification (ID), a System Administrator can create, generate, or otherwise designate processing rules for the source network, source domain, and source ID attributes of a message. Similarly, a Domain Administrator can create, generate, or otherwise designate processing rules for the source network, source domain, and source ID attributes of a message. Further, a Recipient user can create, generate, or otherwise designate processing rules for the source network, source domain, and source ID attributes of a message. Such message attributes are merely illustrative for one embodiment, and fewer, more, and/or other attributes (e.g., message length, message encryption, message coding, message recipient/address (domain, network, and/or user), message compression, message format, message type, message header, message data, message tail, digital certificate, envelope information/data, etc.) can be employed based on the embodiment. Similarly, although the illustrated embodiments include hierarchical levels with associated users having privileges to provide message processing rules based on the same message attributes, in some embodiments, one hierarchical level of users (e.g., System Administrators) may be allowed to provide message processing rules for a message attribute, while other hierarchical level(s) of system users may not be allowed to provide message processing rules for the same message attribute, and vice-versa.

The disclosed system 12 can thus include a database to associate system users, where the term “system user” can be understood herein to generally include different types of users (e.g., System Administrators, Domain Administrators, Recipient users, etc.), where system users can be associated with login name and a password, and the system 12 can associate a login name and password with, for example, user status (e.g., user level, domain administration level, system administration level), user preferences, settings, configurations, message processing rules, and other information and/or data that one of ordinary skill in the art will recognize as being associated with a system user. Further, the login name and password can be associated with a network, a domain, and/or a group (as provided herein).

In one embodiment, the disclosed methods and systems can allow a group of users to be associated with single login name and password. For example, users from a domain can be provided with a single login name and password. Those of ordinary skill will recognize that such example can be extended to allow a group(s) of users from a domain to have a single login name and password. Further, a group(s) of domains can be provided with a single login name and password. It can thus be recognized that a group can be understood to be another hierarchical level, such that message processing can be performed, in one example, at a system group level, a system level, a domain group level, a domain level, a user group level, and a user level. As provided herein previously, the illustrated methods and systems can be understood to be extended to groups at one or more levels, and also to other hierarchical levels.

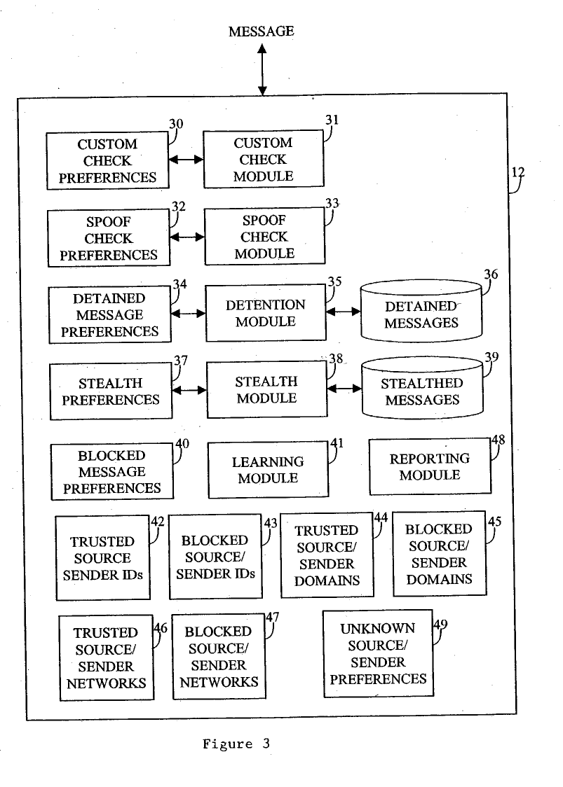

FIG. 3 thus provides an illustrative block diagram displaying some exemplary components of a system 12 as provided herein, where such system 12 can receive and/or deliver a message from/to a network and/or another entity and/or medium. As provided herein, the system 12 can include message processing rules and/or actions that can be based on message attributes, such as source ID 42, 43, source domain 44, 45 and source network 46, 47. Accordingly, in the illustrated system 12, a system user can establish lists of “trusted” source IDs 42, source domains 44, and source networks 46. Similarly, a user can establish lists of “blocked” source IDs 43, source domains 45, and source networks 47. Such associations can further be associated with preferences based on processing actions for such categories (e.g., “trusted” can be associated with one or more processing actions, “blocked” can be associated with one or more processing action, “unknown” can be associated with one or more processing action, “stealthed” can be associated with one or more processing action, etc.). As provided previously herein, although such “lists” can be represented individually in the illustrated embodiment, one of ordinary skill will recognize that such lists can be combined into one or more such lists, and accordingly, other components of the illustrated embodiments can be combined and/or divided without departing from the scope of the disclosed methods and systems. Such lists can thus include or otherwise be associated with the aforementioned filters. A “list” can otherwise be understood more generally to be an association of data.

With reference to the FIG. 3 illustrative system, specified modules can be understood to be, in one embodiment, a software program and/or set of processor instructions, although such modules can be implemented in hardware and/or software.

In an embodiment, a system user can provide configuration data and/or message processing rules related respectively to trusted and/or blocked messages. In the illustrated system embodiment, trusted message processing rules (e.g., processing actions) are not provided (e.g., forward trusted message to another user/network, autoreply, etc.) as such messages can be understood to be delivered (e.g., default processing action) to a Recipient user, while in the illustrated embodiments, a system user (e.g., System Administrator, Domain Administrator, Recipient user) can provide blocked message preferences 40 and/or message processing rules/actions that can be applied based on the message attribute for which the message is blocked. For example, a Recipient user may have different blocked message processing rules for messages blocked based on source ID, source domain, and/or source network. In one embodiment, options and/or processing actions for blocked messages can include invoking a detention module 35 to detain the blocked message in a message detention area 36, invoking or otherwise applying a stealth module 38 that can send or otherwise transmit an error code and/or an error message, where such condition can cause the message sender/source and/or detain the message in a stealth area 39, and delete and/or purge the blocked message, where such blocked-message options are provided for illustration and not limitation. In one embodiment, the unknown recipient message can include an error message. Transmitting the unknown recipient error message can include generating an error code, and transmitting the error code based on the message sender and/or source. Transmitting the message can also include transmitting a customized message, where the customized message can be based on a preference associated with at least one system user.

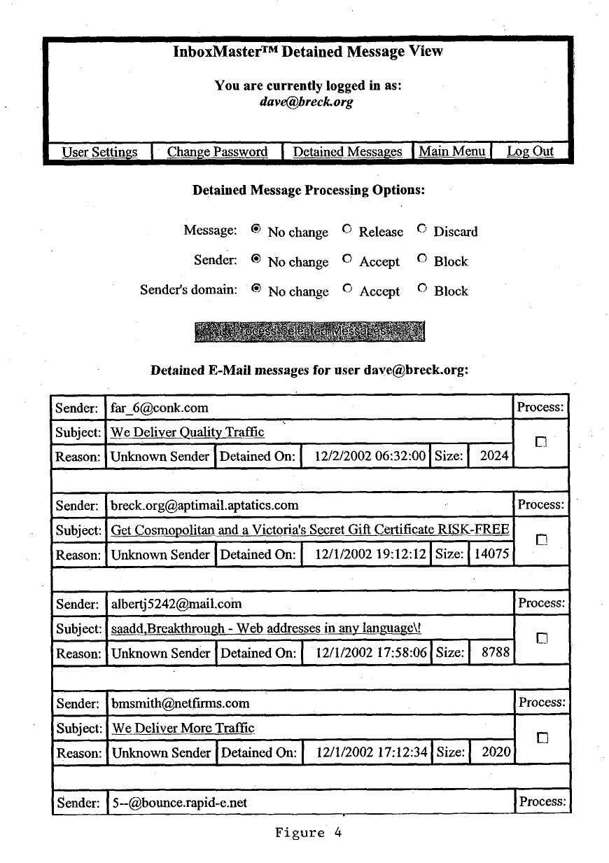

Accordingly, in the disclosed methods and systems a detained message can be understood to be a message that was not delivered to the Recipient user based on the hierarchical message processing rules, where such detained message may be accessed by the Recipient user at the Recipient user's option. The disclosed methods and systems thus allow for messages to be detained in a location 36 that can be accessed by the Recipient user at the Recipient user's option. FIG. 4 provides one exemplary interface for allowing a Recipient user to manage detained messages and determine and/or specify processing rules/actions for such messages, where such management can include viewing data associated with a detained message(s), deleting a detained message(s), and/or releasing a detained message(s) from the detained area to the Recipient user. In one embodiment, the detained area can thus be understood to be a queue, linked list, database, or other memory and/or data structure that can be queried by a user. Referring back to FIG. 3, a system user thus can also manage the detained area by providing configuration data for detained messages 34 that can include, for example, a time period for which messages may remain in the detained area before being deleted. Other management options for the detained area 36 may be provided.

The FIG. 3 stealth module 38 can be understood to be a process that can be applied to a message, where the message is received from a message source/sender and intended for delivery to a Recipient user. The stealth module 38 can cause the message source/sender to be provided with an error message that the intended Recipient user is not valid, does not exist, and/or is unknown (i.e., message attributes, e.g., source ID, source domain, and/or source network, may be neither trusted nor blocked at hierarchical level(s), or otherwise such attributes may not be determined), with such examples provided for illustration and not limitation. The error code can be based on a message protocol, where the message protocol is associated with the received message. For example, in one embodiment where the message protocol is SMTP, the error condition can be error condition 550. Additionally and/or optionally, the methods and systems can provide a user-customized stealth message that can be one of numerous stealth preferences 37. In one embodiment, stealthed messages may be stored in a stealth area 39, and/or in some embodiments, stealthed messages can be processed based on blocked message processing rules, spoofed message processing rules, and/or unknown sender/source message processing rules.

With reference to FIG. 2, the disclosed methods and systems can allow the system to provide the sender's message relay system 20 with an error code that can be based on the message protocol employed by the sender's message relay system 20 to transmit the message. Accordingly, the illustrated message sender 22 of FIG. 3 may be provided with an error message generated by the sender's message relay system 20, rather than, and/or in addition to, an error message provided by the system 12. In some embodiments, a message protocol, including for example SMTP, can allow the system 12 to return an error code and an error message, and accordingly, the disclosed methods and systems can transmit a system user customized error message.

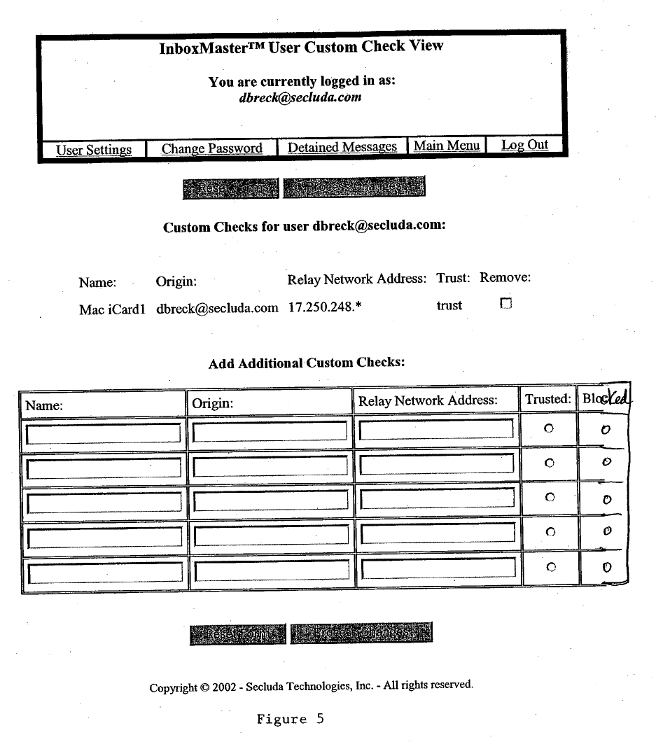

As FIG. 3 also indicates, the disclosed methods and systems also allow a system user to perform “custom checks” that can be understood herein as one or more message processing rules for authenticating incoming messages based on a user's specifications. In one embodiment, custom checks can be employed for rule exception conditions, or to specify exceptions to otherwise provided rules, although the custom check(s)/rule(s) can be used in a variety of embodiments. Custom checks can be performed upon receipt of an incoming message. As FIG. 5 indicates, a user interface or other input means can be provided to allow a user to specify custom checks. As FIG. 5 indicates, a custom check can include a name, an origin that can include one or more source IDs, source domain(s), and/or one or more pattern matches of the source ID(s) and/or source domain(s), where such pattern matching can utilize one or more wildcards in one or more fields, and a designation as trusted and/or blocked. A message can thus be processed based on the recipient's message processing rules for trusted or blocked 40 messages.

“Spoofing” can be understood herein as an attempt by a source to “forge” or otherwise disguise the sender/source and/or to forge the identity of the Recipient user and/or another source that the Recipient user may be likely to trust (e.g., another source within the Recipient user's domain). For the illustrated embodiments, one method for spoofing can include a message source appearing as a source and/or source within a network and/or domain associated with the Recipient user, as recipient networks, domains, and/or users may be likely to trust messages that appear to be from within their respective network and/or domain. One of ordinary skill will thus understand that in some systems, spoofing may allow a delivery of messages that may otherwise not be desired. With respect to the exemplary embodiments of the disclosed methods and systems, spoofing can be understood to be an attempt to appear as a “trusted” source/sender of a message.

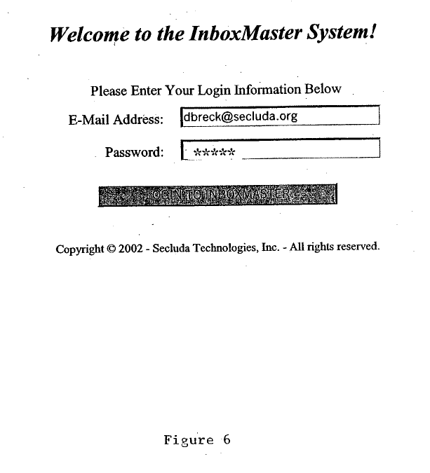

The disclosed methods and systems can thus allow or otherwise include a means to authenticate a Recipient user, a Domain Administrator, and/or a System Administrator associated with the system 12. In one embodiment, an authentication means can be provided via a user interface such as the user interface of FIG. 6 that can request a login name and password from the system user. When the system 12 receives a message that includes a message attribute or other data indicating that the sender/source is from within the system (e.g., a domain within the system, and/or a user within one of the system domains), the system 12 can determine whether the message source is associated with an acceptable domain and/or network for the purported system user who is the sender/source, and/or perform another type of authorization and/or validation that can indicate whether the source who is purportedly a system user, is actually the system user. In one embodiment, digital certificates can be used for authentication, although such example is provided for illustration and not limitation, and other types of encoding and/or authentication schemes can be used. In some embodiments, authentication can be based on AUTH data, based on a network entity (e.g. IP address) associated with the source, etc.

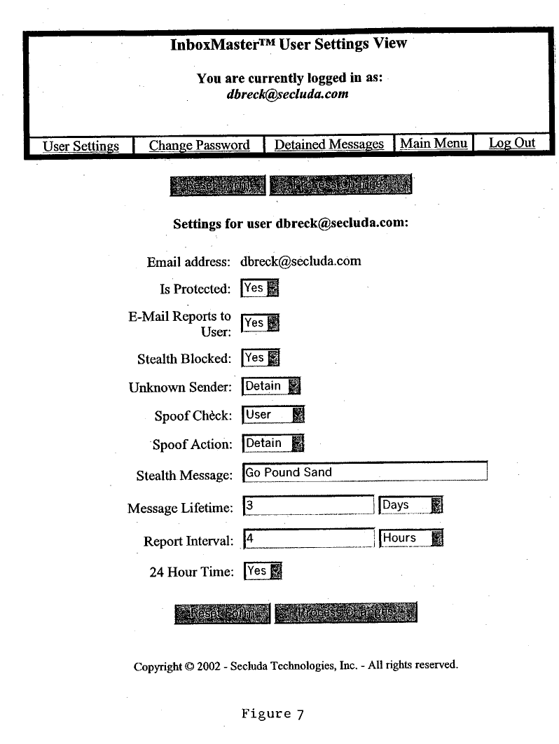

Referring again to FIG. 3, the system 12 can allow a system user to provide spoof checking preferences 32 that can be utilized by a spoof checking module 33. FIG. 7 provides on exemplary interface to allow a system user to provide, select, or otherwise designate spoof checking capabilities and/or preferences, where the system user can determine a spoof checking type by selecting user type, domain type, system type, all types, no types, and a “default” type that can be a level that is one level above the system user (e.g., if the system user is a Domain Administrator, system type spoof checking can be performed). Those of ordinary skill in the art will recognize that such spoof checking type options are provided relative to the disclosed embodiments in which three system user types are provided, and thus embodiments that may use other types of system users, including two types or more than three such system user types, can have associated types of spoof checking. Further, the disclosed methods and systems do not require that the number of spoof checking levels be equated with the number of system user types.

For the illustrated systems and methods, it can be understood that user type spoof checking can verify that a message is associated with message attributes, as provided herein, that can be associated with the source. Domain type spoof checking can be understood to verify that the message is sent from a domain associated with the sender/source. System type spoof checking can be understood to verify that the message is sent from a system associated with the sender/source.

As FIG. 7 also indicates, a system user can provide a spoof preference 32 to determine whether the spoofed module 33 should process spoof messages, with exemplary options including treating a spoofed message as detained, discarded, or accepted (e.g., transmitted to the Recipient user), although other processing actions/options can be provided.

Referring again to FIG. 3, the system 12 can include a learning module 41 that can include, for example, a module to update a system user's “trusted” source ID list and/or another list and/or rule/association based on messages sent by the system user to others. Accordingly, in an email embodiment, a system user may send an email to another, and the learning module 41 may cause the system user's trusted source ID list to be updated accordingly with the addressee's ID. In some embodiments, such updating may occur if the addressee is not designated as blocked.

In one embodiment, the learning module 41 can employ a natural language processor to determine whether messages transmitted by a system user to an addressee may indicate that the addressee can be included in the system user's trusted or blocked source ID lists.

In some embodiments, the disclosed methods and systems can allow an address book from an application, or another type of data file to be imported into the system and associated with a system user's preferences where such imported data can be associated with trusted data/information, blocked data/information, or another type of data/information.

In the illustrated embodiments, when a source (e.g., source ID, source domain, and/or source network) is newly associated with a trusted state and/or designation, and/or a blocked state and/or designation, where such new association can be provided manually (e.g., user interface/preferences, custom preferences), automatically (e.g., learning module), and/or via an import from a data file as provided herein, the disclosed methods and systems can include processor instructions to survey and/or otherwise inventory the detained message area 36, and to process detained messages (e.g., apply processing action) in accordance with such new associations. For example, when the new association can be a trust association, and an associated system user (e.g., Recipient user) is associated with a message processing rule to deliver/relay trusted messages to a Recipient user, such survey of the detained area can cause a release and/or relay of previously detained messages to the Recipient user, where such previously detained messages can be associated (e.g., via a message attribute) with the newly trusted source. In another example, where a system user (e.g., Recipient user) may have a message processing rule to delete blocked messages, a new association may cause an automatic survey of the detained area to delete detained messages. Those of ordinary skill in the art will recognize that the aforementioned examples are provided for illustration and not limitation.

Accordingly, it can be understood for the disclosed methods and systems that a change and/or update to preferences, whether such change/update is caused automatically and/or manually, can cause an update to at least the detained messages, where such update can cause an application of at least one processing rule and/or action, where the processing rule and/or action can be associated with the update (e.g., if the update is related to a trust, the processing rule can be associated with trusted message processing rules). In some embodiments where blocked and/or stealthed messages are maintained, processing rules and/or actions can be automatically applied to such stealthed and/or blocked messages based on the updated preferences. The methods and systems thus include a means for determining whether an change and/or update to user preferences occurred, and based on the determination, processing at least the detained messages, where the processing is based on processing rules associated with the system user and the update to the preferences.

The disclosed methods and systems also allow system users to provide processing preferences for a message from unknown sources 49, where an unknown source is a source that may be neither trusted nor blocked. Preferences for unknown sources 49 can include, for example, delivering/relaying the message to the recipient (system) user, detaining the message, discarding the message, stealthing the message source, forwarding the message to a spam reporting authority, and other actions.

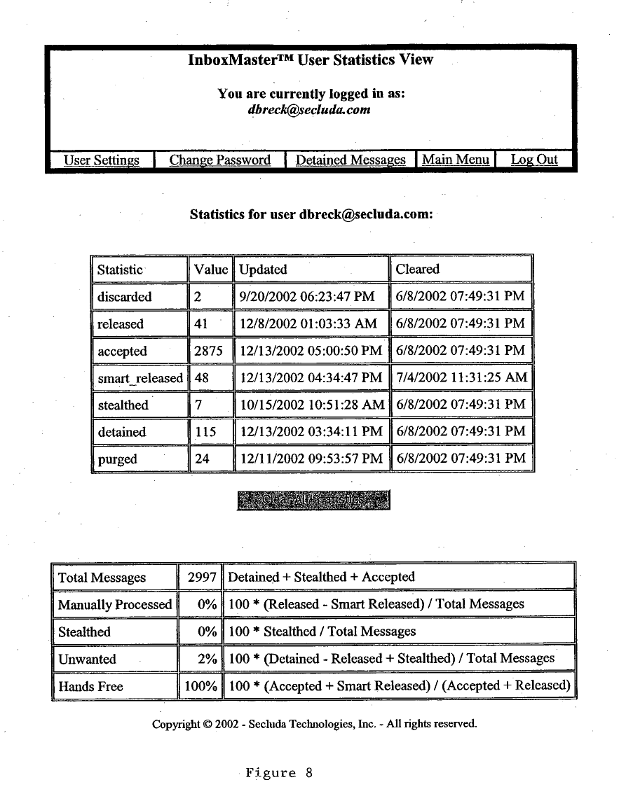

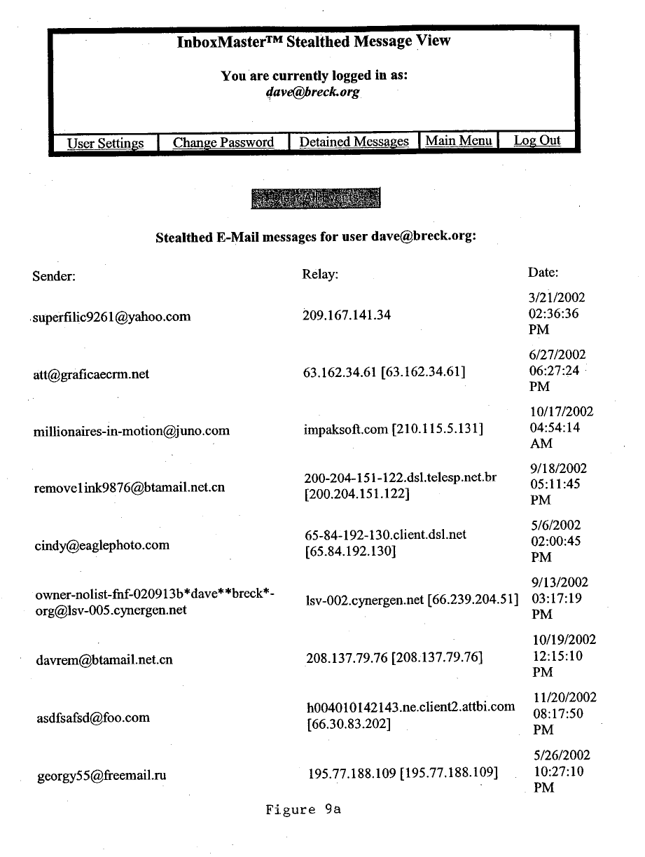

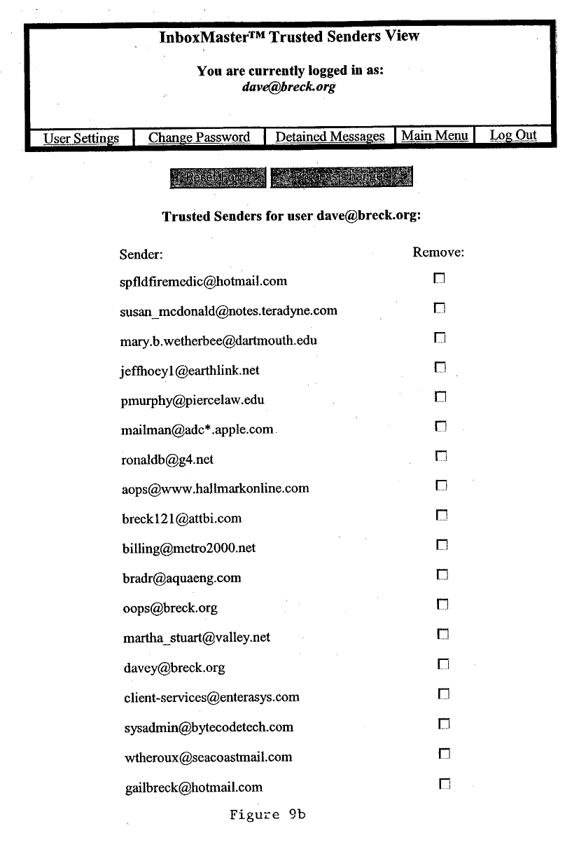

In some embodiments, the methods and systems can allow a system user to receive or otherwise obtain a report and/or statistics based on processed messages, and thus the system 12 can include a reporting module 48. A system user can determine if, when, and/or how often, and/or otherwise schedule, reports are provided to the system user. Reports can be provided via email, for example. FIG. 8 provides one report that includes statistics and other data such as detained message data (e.g., detained messages, statistics), stealth event data, and other data. FIGS. 9a and 9b illustrate a report related to stealthed messages, and an exemplary list of trusted addresses, respectively.

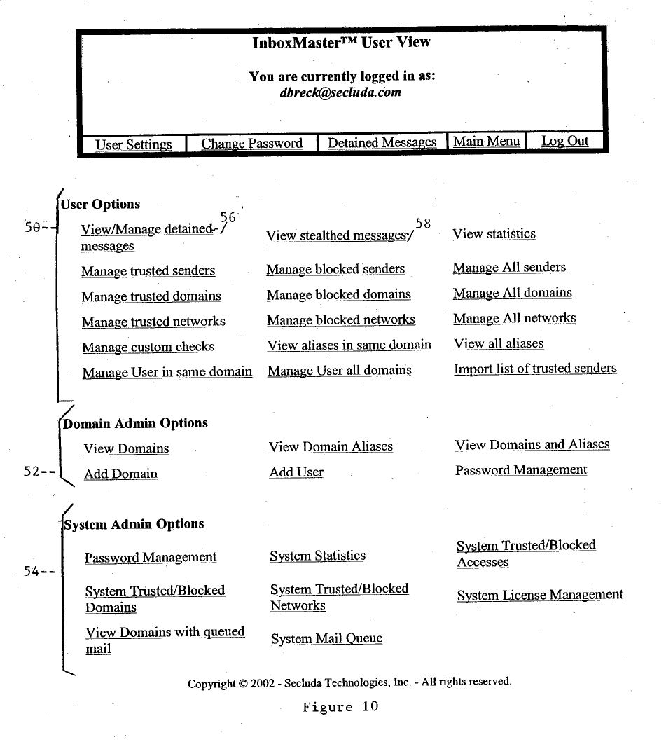

FIG. 10 provides an interface for allowing a system user to manage the aforementioned aspects of the system 12. FIG. 10 provides one example of a user interface for allowing a system user to set preferences, configurations, and other settings. The FIG. 10 illustrative interface can be understood to apply to a System Administrator login account for a system that includes the aforementioned three hierarchical processing levels of System Administrator, Domain Administrator, and Recipient user. As FIG. 3 indicates, a System Administrator may have configuration options 54 that may be in addition to configuration options that are applicable to Recipient users 50 and/or to Domain Administrators 52. In the FIG. 3 embodiment, Domain Administrator configuration options 52 can also include options of Recipient users 50. As FIG. 10 indicates, system users can be associated with one or more aliases that can be understood as alternate references and/or addresses, where such aliases may be of a different user type and/or level. Aliases can be thus be allowed at different system user levels, and accordingly, aliases can be employed in the disclosed methods and systems to process messages.

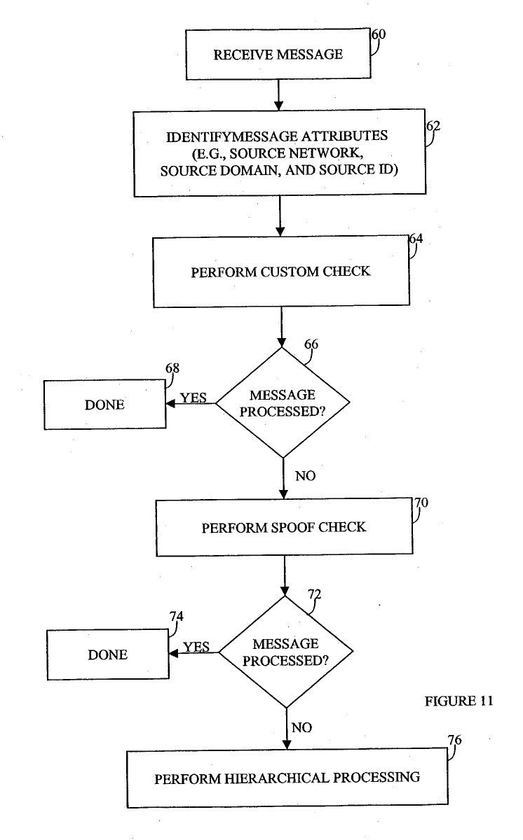

FIG. 11 accordingly provides one embodiment for processing an incoming message to the system 12, where such embodiment can employ a custom checking module and a spoof checking module, although those of ordinary skill will recognize that such individual features may be optionally included, and as with other illustrative embodiments, may be otherwise configured in a message processing system 12 without departing from the scope of the disclosed methods and systems.

As the illustrative FIG. 11 embodiment indicates, a message can be received 60 and message attributes can be identified 62, with those of ordinary skill in the art recognizing that a message and its attributes can be considered a single data message, multiple data messages, and/or data associated with one or more such data messages. For the illustrated embodiments, as provided previously herein, message attributes can include a source ID, a source domain, and a source network. It can also be understood that other data and/or information associated with the message can be identified, such as the Recipient domain and the Recipient user. Message processing and other preferences and/or configuration data associated with the Recipient domain and the Recipient user can be retrieved or otherwise identified to allow processing of the received message. In some embodiments, if either of the Recipient domain and/or Recipient user are not known, the system 12 can provide a message to the source to indicate that the Recipient domain and/or user are unknown, and/or such message can otherwise be processed according to the unknown source preferences 49 associated with, for example, a System Administrator.

As indicated herein, one or more custom checks 64 can be performed by a custom check module 31 based on one or more custom check preferences 30 provided by the Recipient user (or other system/hierarchical level), and accordingly, if the message is processed based on the custom checks 66, the message processing can be considered complete 68. Alternately, if the message is not processed by the custom checks 66, the message can be processed for spoofing 70 by a spoof checking module 33 based on the Recipient user's spoof checking preferences 32. If the message is processed by the spoof checker 72, message processing can be considered complete 74; otherwise 72, message processing can proceed to the aforementioned hierarchical processing 76 based on message attributes.

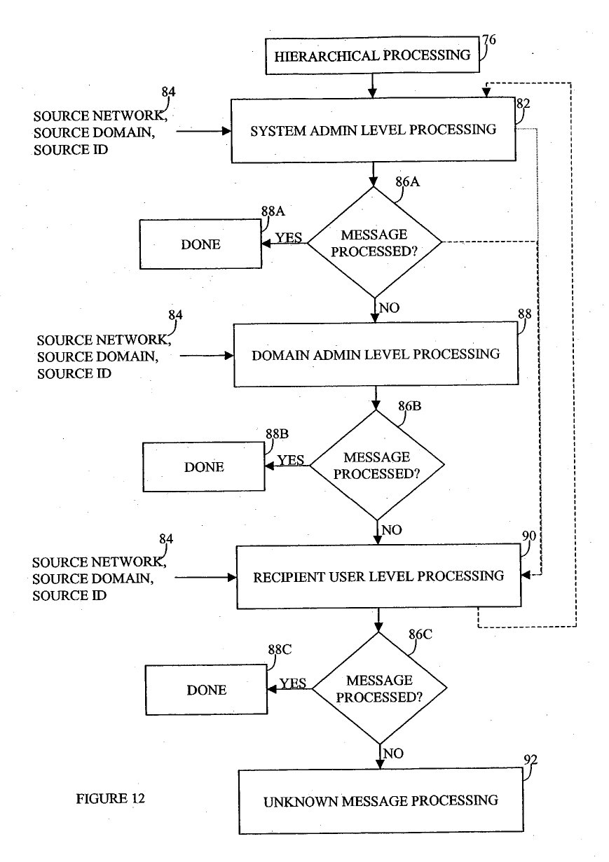

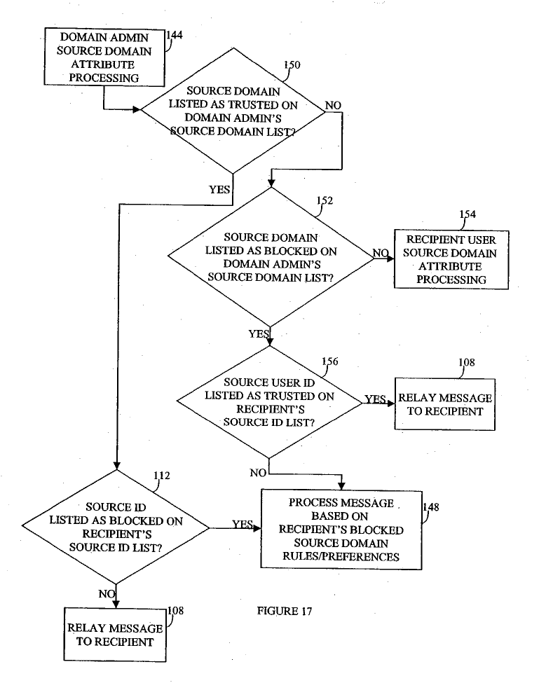

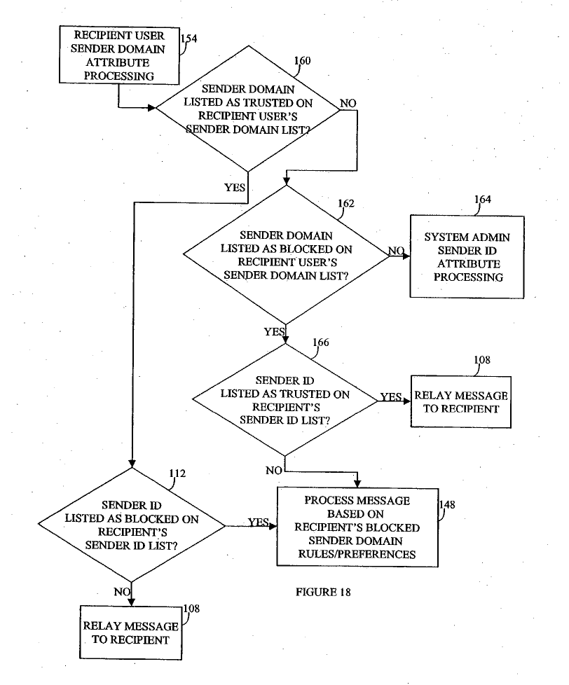

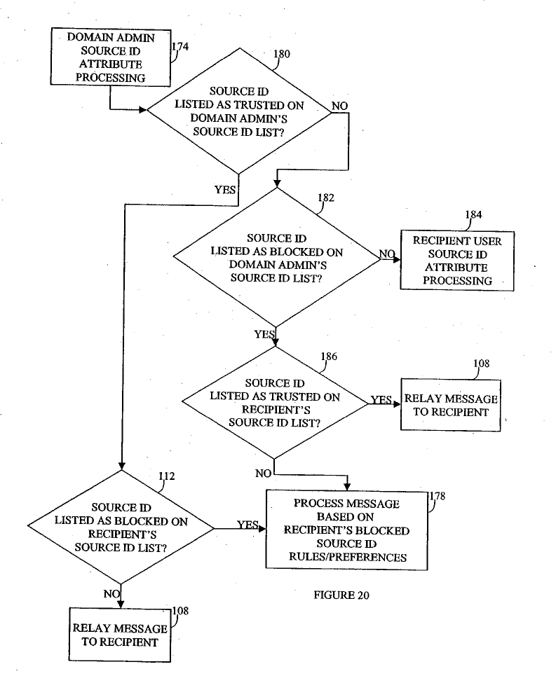

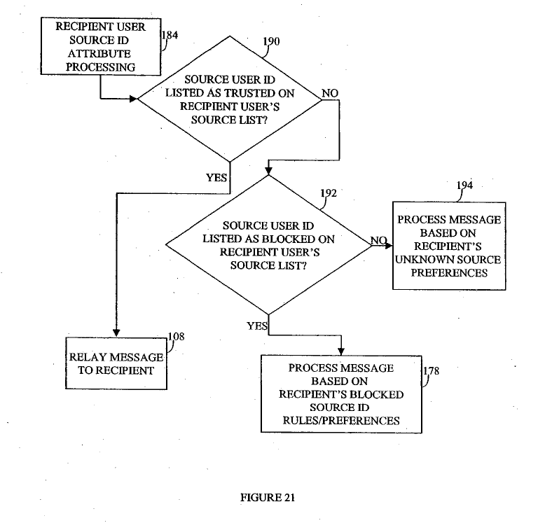

FIGS. 12-21 provide some illustrative embodiments for implementing hierarchical processing 76 for the aforementioned three hierarchical processing levels, although those of ordinary skill in the art will recognize that such hierarchical systems and methods can be varied based on the embodiment, and systems and methods that employ two or more hierarchical levels that allow the levels to provide processing rules and/or actions, and where message processing can occur at the different levels, can be understood herein to be a hierarchical message processing system and method 76.

FIG. 12 provides one embodiment of hierarchical processing 76 where message attributes can be provided to a first hierarchical level for processing 32. In the illustrated embodiments, for incoming messages, order priority can generally be understood to apply first to System Administrators, then Domain Administrators, and then Recipient users. As will be disclosed herein, such order priority can be understood to include rule consideration in the aforementioned order priority scheme, rather than rule application/processing. Accordingly, one of ordinary skill will understand that the disclosed methods and systems for providing hierarchical processing can be performed based on one or more generalized considerations that can be reflected in or otherwise enacted via a processing priority. For example, in the disclosed embodiments, general considerations can include determining that if a System Administrator lists or otherwise associates a “trust” rule with a sender/source system, sender/source network, and/or sender/source ID, a Recipient user may override (e.g., have processing priority relative to) such System Administrator trust as such trust applies to a source ID. Further, for the illustrated systems and methods, a corresponding statement can be made with respect to a source ID that the Recipient user designates as trusted, while the System Administrator may consider the source system, source network, and/or source ID to be blocked. Accordingly, it can be understood that variations can be made to the various generalized considerations and/or order and/or processing priorities. In one example of a variation that is provided for illustration and not limitation, in the illustrated embodiments, a Recipient user may override (e.g., have processing priority with respect to) a System Administrator with respect to a source ID, although in some embodiments, a Recipient user may not be allowed to override a Domain Administrator with respect to a source ID.

With reference to the illustrated embodiments, FIG. 12 provides an exemplary block diagram where a message can generally be processed in a hierarchy that can provide message attributes 84a to a first hierarchical level at a System Administrator level 82, where the message can be processed based on message processing rules, configurations, and/or preferences of a System Administrator, and based on whether the message is processed 86a, the message can be provided to a second hierarchical level that may be a Domain Administrator level 88, where message attributes 84b can be provided and applied against Domain Administrator rules. Based on whether the message is processed by the Domain Administrator rules 86b, the message processing rules of a Recipient user 90 can be applied to the message. As the illustrated embodiment indicates, if the message is not processed upon application of the System Administrator, Domain Administrator, and/or Recipient user rules/preferences/processing actions, the message can be processed based on a fourth hierarchical level that may be referred to as the unknown source rules 92. It can be understood that the unknown source rules 92 can be part of the Recipient user rules 90. Further, an example of the illustrated variability of the disclosed methods and systems can be shown by the dotted connections that provide optional hierarchical processing techniques.

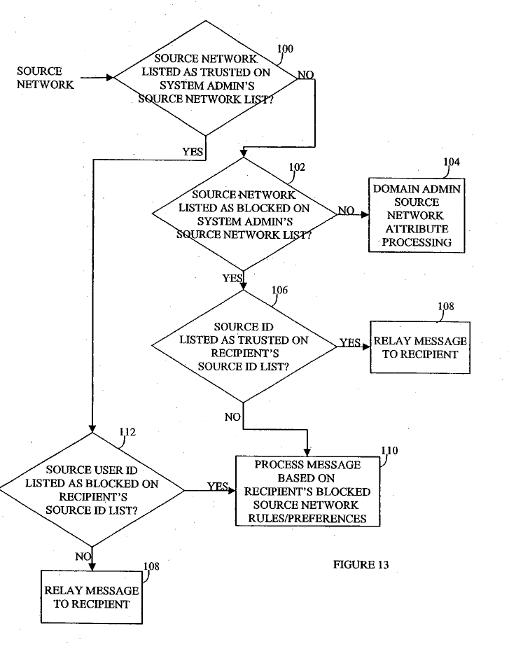

FIG. 13 shows an embodiment of a System Administrator level processing of a sender/source network message attribute. As FIG. 13 indicates, if the message's sender/source network is listed as trusted by the System Administrator (e.g., System Administrator trusted sender/source network list 46 (see FIG. 3)) 100, the message processing may defer to the Recipient user level. At the Recipient user level, the illustrated systems and methods may determine whether the Recipient user is associated with a blocked message source/sender ID list 43 that includes the source/sender ID 112. If the System Administrator trusts the source/sender's network, and the Recipient user has not blocked the source/sender ID, the illustrated methods and systems may relay the message to the Recipient user 108. Alternately, even though the System Administrator may trust the source/sender's network, the Recipient user may block the source/sender ID, and thus the message may be processed based on the Recipient user's blocked source/sender ID preferences 110. Such blocked source/sender ID preferences can include, for example, detaining the message, discarding (e.g., deleting) the message, and/or stealthing the message source/sender (which, as provided herein, can include detaining the message).

As FIG. 13 also indicates, if the source/sender network associated with the message is not listed as or otherwise designated as trusted by the System Administrator 100, the FIG. 13 embodiment determines whether the source network is designated as blocked by the System Administrator 102. If the source network is neither blocked nor trusted by the System Administrator, the processing may proceed to processing the source network at the Domain Administrator hierarchical level 104. Alternately, for the illustrated systems and methods, if the System Administrator associates the source's network with a blocked status 102, the FIG. 13 processing can proceed to determining whether the Recipient user trusts the message's source ID. Accordingly, based on the message source's ID, and whether the Recipient user may associate such source ID with a trusted configuration 106, the illustrated embodiment may relay the message to the Recipient user (e.g., source ID trusted by Recipient user) 108. Alternately, the FIG. 13 embodiment may process the message as a blocked source 110, although those of ordinary skill in the art will recognize that in some embodiments, a variation can include processing the message as an unknown source based on a System Administrator and/or Recipient user preferences, and/or determining whether the message source ID is associated by the Recipient user as a blocked source ID, and processing the message according to the Recipient user's blocked source ID preferences 110. As provided previously herein, many variations of the illustrated embodiments may be performed without departing from the scope of the disclosed methods and systems.

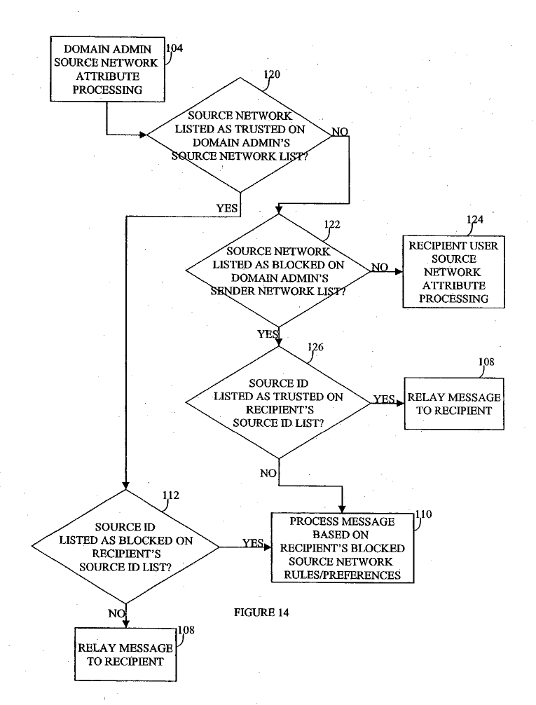

FIG. 14 illustrates one embodiment for a domain administrative level processing 104 for a source network attribute, where such processing may be coordinated with the FIG. 13 processing at the System Administrator level. As FIG. 14 illustrates, the processing may determine whether the Domain Administrator associates the source network with a trusted network 120, and if the source's network is trusted by the Domain Administrator, the processing can determine whether the Recipient user wishes to block the message's source ID 112. If the Recipient user associates the message's source ID with a blocked source ID, then the message can be processed based on the Recipient user's blocked message processing rules/preferences 110, and otherwise, the message may be relayed to the Recipient user 108. With respect to FIGS. 13 and 14, and other Figures, it can be understood that in one embodiment, the illustrated decision at 112 may be followed by a decision to determine whether the message's source ID is blocked by the Recipient user, and accordingly, to process the message based on the Recipient user's blocked message preferences 43 or unknown source preferences 49.

As FIG. 14 indicates, if the Domain Administrator does not associate the source network with a trusted status 120, the processing may query whether the Domain Administrator associates the source network with a blocked status 122. If the Domain Administrator neither associates the source network with a trusted nor blocked status, the processing may continue by processing the source network attribute at a third hierarchical level, or at the Recipient user level 124; however, if the Domain Administrator associates the source network with a blocked status 122, the FIG. 14 embodiment may allow the Recipient user's source ID preferences to determine the message processing. An example of one embodiment where a Recipient user's preferences can determine message processing is shown in FIG. 14, and was described relative to FIG. 13. In some embodiments, a Recipient user may not be allowed to override a Domain Administrator's decision to accept messages from individuals that are associated generally with a network with whom the Domain Administrator associates with a blocked status. In such embodiments, accordingly, the message may be processed based on the Domain Administrator's preferences for blocked networks, blocked domains, and/or blocked source IDs, and/or the Recipient user's preferences for blocked networks, blocked domains, and/or blocked source IDs.

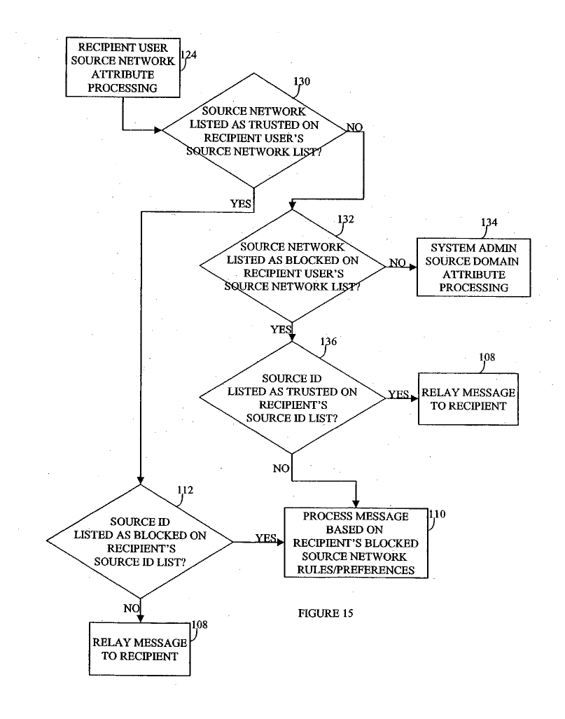

FIG. 15 provides one embodiment for processing a source network attribute at a Recipient user level, where such processing may be based on processing shown in FIGS. 13-14. The FIG. 15 embodiment illustrates that the source network can be compared to a Recipient user's preferences to determine whether the Recipient user considers the source network to be trusted 130, and if so, to further determine whether the Recipient user also associates the source ID with a blocked status 112. This processing and some variations thereon are discussed relative to FIGS. 13-15. In some embodiments, a variation of the illustrated embodiments can include relaying the message to the Recipient user 108 upon determining that the Recipient user trusts the source network 130.

As FIG. 15 also indicates, if the Recipient user does not associate the source network with a trusted status 130, the processing can determine whether the Recipient user's preferences associate the source network with a blocked status 132. If the Recipient user associates the source network with a blocked status, the illustrated embodiment indicates that the Recipient user's preferences associated with the source ID may override the Recipient user's network preferences (see also FIGS. 13-14), although in some embodiments, the message may be processed based on the Recipient user's blocked network, domain, and/or source ID preferences. As FIG. 15 illustrates, if the source network is neither associated with a blocked nor trusted status, the message processing can continue in accordance with a System Administrator hierarchical level processing of a source domain attribute 134.

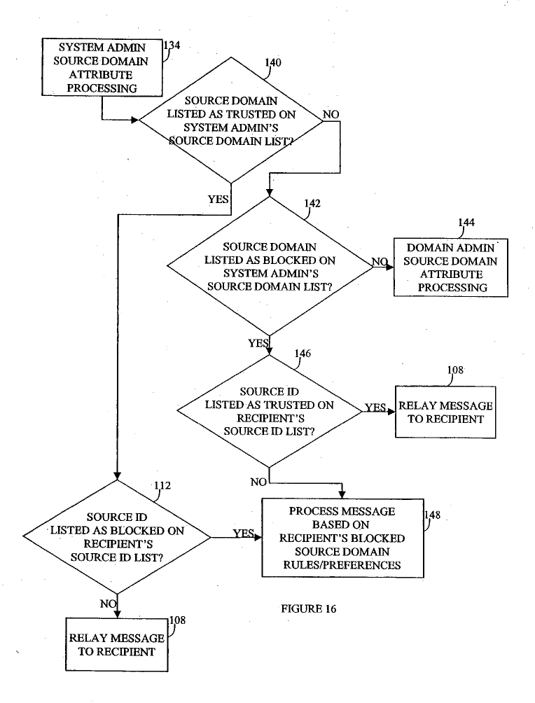

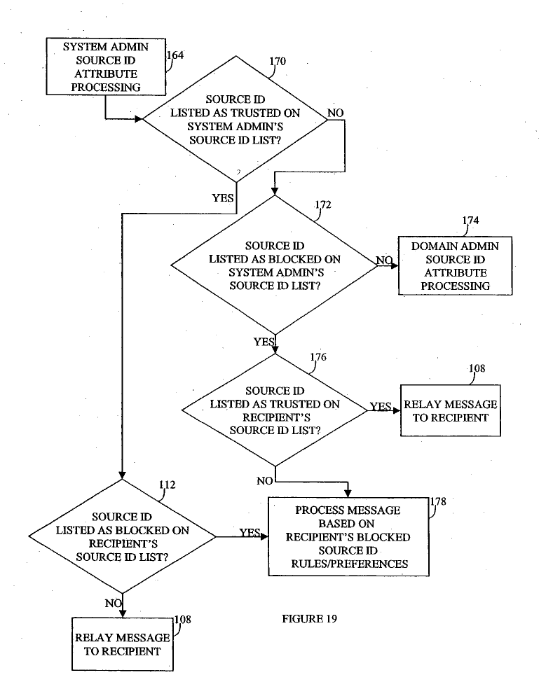

With reference to FIGS. 16-18, illustrated are message processing embodiments according to the disclosed methods and systems for the three hierarchical levels (System Administrator, Domain Administrator, Recipient user), respectively, where such message processing is based on the source domain attribute of the message. Further, FIGS. 19-21 illustrate one embodiment for processing the source ID attribute at the three hierarchical levels, respectively. Accordingly, the embodiments disclosed in FIGS. 13-21 include one embodiment where single attributes of a message can be individually and sequentially processed at the three hierarchical processing levels, and thus the one or more message attributes can be understood to be associated with an order priority. In the illustrated embodiments, the message attribute order priority can include source network, source domain, and source ID. As the illustrated embodiments indicate, such priorities of message attribute can be further based on the processing hierarchy (e.g., processing the System Administrator level for source network can include considering Recipient user level processing of source ID).

Those with ordinary skill in the art will thus recognize that in one embodiment of the disclosed methods and systems, a “guardian” feature can be provided such that a Recipient user (“ward”), for example, may not be allowed to override settings of a higher level system user (e.g., Domain Administrator) (“guardian”). In some embodiments, the ward(s) may not be allowed to edit, view, or otherwise provide preferences as provided herein, and such preferences (e.g., trusted, blocked, detained, spoofing, custom checks, etc.) may be associated with preferences of a guardian and/or determined or otherwise designated by a guardian. Accordingly, a ward may not be allowed to view detained messages, for example. In some embodiments, a ward may be provided with limited preferences. In one example of implementing a guardian feature, as provided herein, more than the three hierarchical levels can be provided, and in one embodiment, multiple Recipient users (e.g., children) can be associated into a group (e.g., parent) that can be further associated with a Group Administrator. The Group Administrator may be provided order priority between the Recipient users and the Domain Administrator in one embodiment. In such an embodiment, as provided previously herein, the Group Administrator may not allow a Recipient user within the group to override the Group Administrator (e.g., the Group Administrator may have processing priority relative to the Recipient user). Those with ordinary skill in the art will thus recognize that such an embodiment can allow for multiple groups of users, and further, groups of domains may be allowed, and in accordance with the aforementioned ability to include multiple hierarchical levels, in some embodiments, groups of groups can be allowed.

The disclosed methods and systems for hierarchical processing of incoming messages can also be applied to outgoing messages, and with reference to FIG. 2, for example, a message generated by a “Recipient user” may be provided to the system 12 for transmission, where such outgoing message can be processed using the same and/or similar hierarchical processing levels; however, the outgoing message processing may be understood to traverse the aforementioned hierarchical levels with an order priority that may be considered generally reverse to the order priority of incoming messages. Using the Group Administrator as an example, where the Group Administrator is a parent, and the associated group Recipient users are the children, and returning to the incoming message processing, if a parent does not want the children to receive messages from a given source, the parent can associate such source ID with a blocked status to prevent delivery to the children; however, with respect to outgoing message processing, such blocked status by the parent can further be associated with outgoing messages from the children. Accordingly, the “source ID” for incoming messages can be considered the “addressee ID” for outgoing messages. Messages transmitted by the children can be matched with or otherwise processed and/or filtered against the parent's blocked IDs, where in the present example, such filtering can cause the child's intended outgoing message to an addressee associated as blocked by the parent, to be detained in the parent's detention area 36. In such an embodiment, the parent may view the detained messages to determine that the child attempted to transmit a message to a blocked ID.

Processing outgoing messages can also include processing the outgoing message in a manner that may be associated with the aforementioned spoof checking. Accordingly, in some embodiments, regardless of whether an outgoing message may be considered acceptable for processing (e.g., transmission) based on the (reverse) hierarchical processing, the methods and systems may validate that the system user sending the message is authorized to send the message, and can validate the identity of the system user. As provided previously herein with respect to spoof checking, methods of validating the system user can vary, and can include data based on network entity, login name and password, digital certificate, AUTH data, and other data, with such examples provided for illustration and not limitation. Outgoing messages can be queued by the system 12 for processing. It can be understood that the user validation for outgoing messages can be performed before or after hierarchical processing. In some embodiments, hierarchical processing of outgoing (and/or incoming) messages may not be performed, for example. Outgoing message processing can thus also include custom checks. In some embodiments, a system user may have system preferences 31-49 that may be different for incoming messages and outgoing messages.

Accordingly, for the illustrated embodiments, message attributes for outgoing messages can also include source ID, source domain, and source network (e.g., for the system user who is sending the message), and may also include addressee ID, addressee domain, and addressee network. Further, those of ordinary skill will recognize that for the illustrated embodiments that include three hierarchical processing levels, outgoing messages can be processed at a Recipient user level, then Domain Administrator level, and then System Administrator level, in reverse to FIGS. 13-21. In one embodiment for outgoing messages, unless a higher processing level associates at least one of the addressee ID, addressee domain, and/or addressee network with a blocked status, the message may be transmitted. As provided herein, outgoing messages may also be processed for spoof checking and custom checks. Accordingly, with reference to FIGS. 12-21, message attributes of outgoing messages can be given order priority, and can be sequentially processed in a reverse hierarchical order to FIGS. 12-21. For example, such processing can include first processing the addressee ID at the Recipient user level, then Domain Administrator level, and then System Administrator level, and then processing the addressee domain at the Recipient user, then Domain Administrator, and then System Administrator levels, etc. In one embodiment, outgoing message processing may process more than one attribute of the outgoing message at one processing level (e.g., Domain Administrator level) before moving to a next higher processing level (e.g., System Administrator level), where in such an embodiment, the hierarchical levels may be traversed once per outgoing message.

It can thus be understood that references herein to a trusted “source ID”, blocked “source domain”, etc., can be understood in one embodiment to be an association by a system user of a message attribute (e.g., address and/or part of an address) with a given status and/or state (e.g., trusted, blocked). Accordingly, regardless of whether incoming message processing and/or outgoing message processing may be performed, the disclosed methods and system can determine whether the address associated with the message to be processed is otherwise associated with a given state (e.g., trusted, blocked) by a given system user (e.g., System Administrator, Domain Administrator, Recipient user).

One of ordinary skill will recognize that the disclosed methods and systems can be applied to a message that includes telephony data. In such an embodiment where the message can be a telephone call, for example, based on the illustrated hierarchical users, a Recipient user may be a telephone customer, while a Domain Administrator may be a telephone company or other exchange. Accordingly, the telephone customer can provide preferences 31-49 based on message attributes, where message attributes can include the source ID (e.g., telephone number from which the call/message is being placed), and the telephone customer/Recipient user can associate such message attributes (e.g., source ID) with a trusted or blocked status. As provided herein, processing actions can include providing an error code (e.g., stealthing the message, selecting an automated and/or user-customized recorded message), detaining the message/call (e.g., sending/forwarding to voice mail), forwarding the message/call, learning/updating the preferences based on telephone calls, and other options as provided herein, with such options provided for illustration and not limitation.

In some embodiments of the systems and methods, automatic and/or dynamic instantiation of a system user can be provided. In such embodiments, based on data that can be external to the system 12, such as data from a Point-of-Presence (POP) server, a SMTP server, data based on a protocol such as Lightweight Directory Access Protocol (LDAP) and/or another directory services protocol, login and password data, and/or network entity data, the disclosed methods and systems can validate a system user based on a domain, domain group, and/or another hierarchical level as provided herein that can be associated with the system user, such that the system can dynamically generate and/or instantiate a system user account, and in some embodiments, associate therewith a default set of preferences 31-49, etc. Although the dynamic process can be based on external data, system data can be used in some embodiments.

What has thus been described are methods and systems for processing a message, the methods and systems including providing a first level of message processing rules, providing at least one second level of message processing rules, determining at least one message attribute associated with the message, and based on the determined message attribute(s), the first level of message processing rules, and the at least one second level of message processing rules, processing the message based on preferences associated with a trusted message, a blocked message, or an unknown message. The preferences can be associated with the first level and/or the second level.

The methods and systems described herein are not limited to a particular hardware or software configuration, and may find applicability in many computing, communications, or processing environments. The methods and systems can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted.

As provided herein, the processor(s) can thus be embedded in one or more devices that can be operated independently or together in a networked environment, where the network can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a processor” or “the processor” can be understood to include one or more processors that can communicate in a stand-alone and/or a distributed environment(s), and can thus can be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network using a variety of communications protocols, and unless otherwise specified, can be arranged to include a combination of external and internal memory devices, where such memory can be contiguous and/or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation, and can include other persistent storage schemes.

References to a network, unless provided otherwise, can include one or more network entities (e.g., hosts as referenced by address and/or name, networks and/or subnets as referenced by address, wildcard pattern match of address, designated range of address, subnet notation CIDR, and other similar network specifications) and/or one or more intranets and/or the internet.

References herein to “preferences”, “configuration”, “settings”, “processing action(s)”, and/or “processing rule(s)” can be understood to be data to facilitate message processing, and can thus be understood to be interchangeable in some embodiments. In some embodiments, preferences (and configuration, settings, and/or processing actions and/or rules) can include data associated with one or more of items 30-49 of FIG. 3, although other system components not illustrated in FIG. 3 may also be included within the scope of preferences.

Although the methods and systems have been described relative to a specific embodiment thereof, they are not so limited. Obviously many modifications and variations may become apparent in light of the above teachings. For example, although the disclosed methods and systems are described relative to a system/server 12 that may be understood to include a gateway in the illustrated embodiments, such methods and systems can be implemented with, for example, the recipient's mail delivery server 16, the SMTP server 14, an application associated with the recipient (e.g., email application), and/or distributed throughout such servers and/or applications. Accordingly, the system/server 12 of the illustrated embodiments can be understood to be server in the client-server paradigm, where such server 12 can include processor instructions that can reside on a separate processor, or the same processor as the client. Further, the system/server 12, in some embodiments, can be understood to include a hardware device and/or a processor, such that the server can be associated with, for example, an IP address, although such example is provided for illustration and not limitation. In one embodiment, the system/server 12 can be associated with a network.

Although the illustrated embodiments of the disclosed methods and systems processed incoming messages per attribute amongst the different hierarchical levels, multiple attributes can be processed at the same time at a given hierarchical level, where in some embodiments, the hierarchical levels may be traversed once per message. Also, although the illustrated methods and systems based processing decisions/rules on message attributes related to source network, source domain, and/or source ID, those of ordinary skill can recognize that other message attributes can additionally and/or optionally be used to process messages.

Many additional changes in the details, materials, and arrangement of parts, herein described and illustrated, can be made by those skilled in the art. Accordingly, it will be understood that the following claims are not to be limited to the embodiments disclosed herein, can include practices otherwise than specifically described, and are to be interpreted as broadly as allowed under the law.

What is claimed is:

1. A method for processing a message, the method comprising:
identifying at least one message recipient,
associating the at least one recipient with at least two processing levels, the at least two processing levels including at least one processing rule,
associating at least one message attribute with the message, and,
processing the message based on applying the at least one message attribute to the at least one processing rule in the at least two processing levels.

2. A method according to claim 1, where the message includes at least one of an email, telephony data, Short Message Service (SMS) data, at least one ASCII character, at least one non-ASCII character, and at least one binary digit.

3. A method according to claim 1, where the at least one recipient includes at least one of: at least one user, at least one domain, at least one network, and at least one server.

4. A method according to claim 1, where the at least two processing levels include at least one of a Recipient user level, a user group level, a domain administrator level, a domain group administrator level, and a system administrator level.

5. A method according to claim 1, where the at least one processing rule includes at least one association, the at least one association including at least one address identifier.

6. A method according to claim 5, where the at least one address identifier includes at least one user ID, at least one domain, and at least one network.

7. A method according to claim 5, where the at least one association includes at least one wildcard.

8. A method according to claim 1, where the at least one processing rule includes at least one filter.

9. A method according to claim 1, where the at least one processing rule includes at least one association with at least one of: a trusted address and a blocked address.

10. A method according to claim 1, where the at least one message attribute includes at least one of: a source address, a source recipient user, a source domain, a source network, a recipient address, a recipient user, a recipient domain, a recipient network, a message length, message encryption, message coding, message compression, a message format, a message type, a message header, message data, a message tail, a digital certificate, and envelope data.

11. A method according to claim 1, where processing the message includes at least one of: detaining the message, deleting the message, and relaying the message to the at least one recipient.

12. A method according to claim 1, where processing the message includes:
associating a source with the message, and,
providing an error message to the source.

13. A method according to claim 12, where providing an error message includes providing an error message based on at least one preference of the at least one recipient.

14. A method according to claim 1, further including updating the at least one processing rule based on at least one message transmitted by the at least one recipient.

15. A method according to claim 1, further including updating the at least one processing rule based on a learning module.

16. A method according to claim 1, where the at least one processing rule includes a custom rule.

17. A method according to claim 1, where the at least one processing rule includes a spoof check.

18. A method according to claim 17, where the spoof check includes at least one of a user type, a domain type, and a system type.

19. A method according to claim 1, further including associating at least one of a processing priority and an order priority with the at least two processing levels.

20. A method according to claim 1, further including associating at least one of an order priority and a processing priority with the at least one message attribute, and processing the at least one message attribute at the at least two processing levels based on at least one of the order priority and the processing priority.

21. A method according to claim 1, where processing the message includes:
detaining the message, and
providing an interface to allow the at least one recipient to process the detained message.

22. A method according to claim 1, where processing the message includes transmitting an unknown recipient message to the message source.

23. A method for processing a message, the method comprising:
associating a first recipient with at least one message attribute, where the first recipient and the at least one message attribute are further associated with a trusted status or a blocked status,
associating at least one second recipient with at least one message attribute, where the at least one second recipient and the at least one message attribute are further associated with a trusted status or a blocked status,
determining at least one message attribute associated with the message, and,
comparing at least one of the determined at least one message attribute to:
the at least one message -attribute associated with the first recipient, and,
the at least one message attribute associated with the at least one second recipient, and, processing the message based on the comparison.

24. A method according to claim 23, where the comparing is based on at least one of: an order priority associated with the first recipient and the at least one second recipient, and an order priority associated with the determined at least one message attribute.

25. A method according to claim 23, where processing the message includes associating a processing priority with the first recipient and the at least one second recipient.

26. A method according to claim 23, where processing the message includes at least one of: relaying the message to at least one of the first recipient and the at least one second recipient, detaining the message, and deleting the message.

27. A method according to claim 23, where comparing further includes comparing the determined at least one message attribute to a custom check.

28. A method according to claim 23, where comparing further includes comparing based on a spoof check.

29. A method according to claim 23, where the message includes at least one of an email, telephony data, Short Message Service (SMS) data, at least one ASCII character, at least one non-ASCII character, and at least one binary digit.

30. A method according to claim 23, where processing the message includes identifying that the determined at least one message attribute is neither trusted nor blocked by the first recipient and the at least one second recipient.

31. A method according to claim 23, further including providing a report to at least one of: the first recipient and the at least one second recipient, the report including data based on processed messages.

32. A method according to claim 23, further including:
based on a source associated with the message, associating at least one of the determined at least one message attributes with a trusted status, the trusted status further associated with at least one of: the first recipient and the at least one second recipient.

33. A method according to claim 23, where:
the first recipient includes at least one of: at least one recipient user, at least one user group administrator, at least one domain administrator, at least one domain group administrator, and at least one system administrator, and,
the at least one second recipient includes at least one of: at least one recipient user, at least one user group administrator, at least one domain administrator, at least one domain group administrator, and at least one system administrator.

34. A method according to claim 23, where the at least one message attribute includes at least one of: a source address, a source recipient user, a source domain, a source network, a recipient address, a recipient user, a recipient domain, a recipient network, a message length, message encryption, message coding, message compression, a message format, a message type, a message header, message data, a message tail, a digital certificate, and envelope data.

35. A method for processing a message, the method comprising:
associating attributes with the message,
based on processing rules of at least two processing levels and the message attributes, classifying the message as one of: trusted, blocked, and unknown, and,
based on the classification, performing at least one of: relaying the message to a recipient, detaining the message, and deleting the message.

36. A method according to claim 35, where associating attributes with the message includes associating at least one of: a source address, a source recipient user, a source domain, a source network, a recipient address, a recipient user, a recipient domain, a recipient network, a message length, message encryption, message coding, message compression, a message format, a message type, a message header, message data, a message tail, a digital certificate, and envelope data.

37. A method according to claim 35, where the at least two processing levels include at least two of: a recipient user, a user group administrator, a domain administrator, a domain group administrator, and a system administrator.

38. A method according to claim 35, where the processing rules include associations of message attributes with at least one of a trusted state and a blocked state.

39. A method according to claim 35, where the processing rules include at least one wildcard.

40. A method for processing a message, the method comprising:
providing a first level of message processing rules,
providing at least one second level of message processing rules,
determining at least one message attribute associated with the message,
based on the determined at least one message attribute, the first level of message processing rules, and the at least one second level of message processing rules, processing the message based on at least one preference associated with a trusted message, a blocked message, or and unknown message.

41. A method according to claim 40, where the first level of message processing rules associates at least one message attribute with a trusted state or a blocked state.

42. A method according to claim 40, where the second level of message processing rules associates at least one message attribute with a trusted state or a blocked state.

43. A method according to claim 40, where processing the message based on at least one preference associated with at least one of a blocked message and an unknown message includes detaining the message.

44. A method according to claim 40, where processing the message based on at least one preference associated with at least one of a blocked message and an unknown message includes sending an error message.

45. A method according to claim 40, where processing the message based on at least one preference associated with a trusted message includes at least one of: relaying the message to a message recipient, and releasing detained messages associated with the message.

46. A method according to claim 40, where the at least one message attribute includes at least one of: a source address, a source recipient user, a source domain, a source network, a recipient address, a recipient user, a recipient domain, a recipient network, a message length, message encryption, message coding, message compression, a message format, a message type, a message header, message data, a message tail, a digital certificate, and envelope data.

47. A method according to claim 40, where providing a first level of message processing rules includes associating at least one message attribute with a trusted state or a blocked state.

48. A method according to claim 40, where providing at least one second level of message processing rules includes associating at least one message attribute with a trusted state or a blocked state.

49. A method according to claim 40, where the at least one preference can be associated with at least one of: the first level and the at least one second level.

50. A method of processing a message, the method comprising:
receiving the message via a message protocol,
associating the message with a source,
based on at least one of the source, the message content, and at least one preference of at least one message recipient, providing an error condition in accordance with the message protocol, the error condition indicating that the message recipient is not valid.

51. A method according to claim 50, where the message protocol includes at least one of SMS, Simple Mail Transfer Protocol (SMTP), and Wireless Application Protocol (WAP).

52. A method according to claim 50, where associating the message with a source includes processing data associated with the message and processing the message data.

53. A method according to claim 50, where the error condition indicating that the message recipient is not valid includes an error condition indicating that the message recipient is not known.

54. A method according to claim 50, where providing the error condition includes transmitting the error condition based on the protocol.

55. A method according to claim 50, where providing the error condition includes associating an error message with the error condition, and where providing an error condition includes providing the error message.

56. A method according to claim 55, where providing the error message includes providing the error message in accordance with the protocol.

57. A method according to claim 55, where providing the error message includes at least one of:
providing a default error message, and,
providing an error message customized by the at least one message recipient.

58. A method according to claim 50, where the message protocol is SMTP, and the error condition is error condition 550.

59. A method according to claim 50, where the at least one message recipient is at least one of a system administrator, a domain administrator, and a recipient user.

60. A method of processing a message, the method comprising:
associating at least one of the message content and the message source with a sender identity, where the sender identity is associated with at least one of a system user and a user in a system domain,
based on at least one first preference of at least one recipient, authenticating the sender identity, and,
based on at least one second preference of the at least one recipient, processing the message.

61. A method according to claim 60, where authenticating the sender identity includes authenticating based on at least one message attribute.

62. A method according to claim 60, where authenticating the sender identity includes authenticating based on at least one of source ID, source domain, and source network.

63. A method according to claim 60, where the at least one first preference includes a spoof check type, where the spoof check type includes at least one of a user type, a domain type, a system type, a default type, and none.

64. A method according to claim 60, where the at least one preference includes at least one preference associated with at least one of a recipient user, a user group administrator, a domain administrator, a group domain administrator, and a system administrator.

65. A method according to claim 60, where the at least one second preference includes a spoof check preference, where the spoof check preference includes at least one of detaining the message, relaying the message to the at least one recipient, blocking the message, deleting the message, forwarding the message, and stealthing the message source.

66. A method according to claim 60, where authenticating the user includes at least one of authenticating the source with the at least one recipient user, authenticating the source with a domain associated with the at least one recipient, and authenticating the source with a system domain.

67. A method according to claim 66, where:
authenticating the source with the at least one recipient user includes authenticating the source ID with a recipient ID,
authenticating the source with a domain associated with the at least one recipient includes authenticating the source domain with a recipient domain, and,
authenticating the source with a system domain includes authenticating the source network with a domain associated with a system, the system associated with the recipient domain.

68. A method according to claim 60, where authenticating includes processing data based on at least one of: a login name and a password, network entity, and AUTH data.
